(19) United States
(12) Patent Application Publication
(10) Pub. No.: US 2016/0103863 A1
(43) Pub. Date: Apr. 14, 2016

(54) METHOD OF MANAGING RELATIONAL DATA IN A SINGLE MATRIX REPRESENTATION

(71) Applicant: DYNASIM TECHNICAL SERVICES, INC., Manhattan, KS (US)

(72) Inventors: CHRISTOPHER LYNN BECKER, MANHATTAN, KS (US); GINA YOUNG BECKER, MANHATTAN, KS (US)

(21) Appl. No.: 14/894,205

(22) PCT Filed: Nov. 27, 2013
(86) PCT No.: PCT/US2013/072369

§ 371 Date: Nov. 25, 2015

Related U.S. Application Data
(60) Provisional application No. 61/827,834, filed on May 28, 2013.

(51) Int. Cl. G06F 17/30

(52) U.S. Cl. CPC G06F 17/30324; G06F 17/30595; G06F 17/30241; G06F 17/30339; G06F 17/30867

(57) ABSTRACT

A method, system, and computer program for managing relational data in a single matrix representation that is generically useful and application-independent. The method, system, and computer program provide for the structured use of single matrix representations for maintaining and managing normalized relational databases in various applications.

### RELATED APPLICATIONS

This patent application claims priority benefit, with regard to all common subject matter, of earlier-filed U.S. Provisional Patent Application No. 61/827,834, filed May 28, 2013, and entitled “DATABASE TECHNOLOGY BASED ON A NEW DATUM CONTEXT MODEL THAT IS GENERICALLY USEFUL FOR BROAD AND VARIOUS APPLICATIONS.” The identified earlier-filed provisional patent application is hereby incorporated by reference in its entirety into the present application.

### FIELD

Embodiments of the invention are broadly directed to a method, system, and computer program for managing multivarious relational data in a single matrix representation that is generically useful, or application-independent. More particularly, embodiments of the invention are directed to providing a new system, method, and computer program for using single matrix representations, such as single database tables, for maintaining and managing normalized relational databases.

### BACKGROUND

The development of the relational model of data (“RMD”) largely replaced other logical models of data that were dependent on ordering, indexing and data paths. Before RMD, programs accessing data were highly dependent on user access paths, which grew complicated and posed severe limitations for programmers. Today, most databases rely on RMD.

According to current database terminology, a typical RMD database table stores data in a two-dimensional matrix. There is a separate table named for each “entity” and a separate column (or “field”) named for each “attribute” of each entity. Each row (or “record” or “tuple”) represents an “instance” of an entity and can hold a datum for each attribute for that instance. The RMD terms, relation, tuple, and attribute correspond closely to the structured query language (“SQL”) terms table, row, and column, respectively. The terminology of RMD and of SQL is used interchangeably in the present disclosure.

A “schema” is a plan for the specific table and column arrangement in any given database. Relational database management systems (“RDBMS”) systems make use of “primary keys” and “foreign keys,” which are columns used to relate data of one table to data of another table. RDBMS systems require high maintenance. Because column headings correspond to real-world variable names and labels that are specific to an application, any addition or deletion of a field in RDBMS systems requires structural database changes, such as addition or deletion of a column in a table, corresponding changes in any related tables, and significant reprogramming of software that is used to write, retrieve and format data. Custom databases can easily become “legacy systems,” meaning that many custom interdependent applications have been developed based on their specific custom schema, making them highly difficult to modernize and replace.

RDBMS technology works adequately in organizations that do not require much customization. Standard RDBMS schema is commonly used to maintain very specific types of data for specific applications, such as human resources or sales. Software has been perfected to perform functions that are common for many companies in these specific areas. Multiple full-time database administrators and programmers can be required, though, to accommodate organizations whose work practices do not comfortably fit into typical models.

When high levels of customization and flexibility are required, database management becomes highly frustrating and prohibitive. Large companies and organizations sometimes try to employ standard RDBMS table schema to manage project data, but the schemas tend to be incredibly complex. The large number of custom fields needed to accommodate various engineers, technicians, accountants, lawyers, and/or managers on various aspects and phases of a complex project; the frequent changes of focus; the need to track various versions and scenarios; the need to retain older datasets; and the need to link and relate large sets of variables for various equipment and samples, make the database administrator's role inconceivably complex. Databases must be highly customized, so that a new database schema must be developed for each new project, and databases must be altered for each change of focus within each project. A single project can involve hundreds of entities and thousands of variables for those entities, wherein each entity requires a separate table, each variable requires a unique column, and each relationship requires a structural link and special programming code. Building and maintaining a database throughout a complex and changing project would require great numbers of database administrators and programmers who have enough project knowledge to understand project team needs and requests. Databases either become too complex and unwieldy for practical use or they are quickly reduced to a level too simple and rigid for practical use. Databases cease to be viewed as useful by project teams, and so enforcement of practices becomes difficult and bureaucratic for managers. Databases for even more narrowed subsets of data involved in complex projects now require a large staff of database managers and software programmers.

The diversity of database schema among various applications creates difficulties in maintaining and accessing data from multiple databases and applications, even when the data is inter-related. It is difficult to agglomerate data from differently configured tables, once the tables have been defined by custom schema and independently utilized. It is common to find interrelated information spread across several databases, configurations for legacy compatibility or size management being examples of such. Databases could be supported by different systems based on distinct models. For the complex project types discussed above, as well as for the emerging and growing needs in cloud computing and data clustering, dissimilar database schema present significant obstacles for integrating services and data for broader use.

A significant problem with databases, generally, is the lack of support for recording temporal dimensions of data: data for which past, present, and possibly even future values and intervals are important. Typically, with RMD, a table is updated by replacing an existing value with a new value so that the old value is not retained. For example, a new address record might replace the old address in several tables, and the old address would not be retained in the database. The lack of a simple way to store temporal dimensions of data without losing its link to current data is a problem that has plagued database research and development groups since before the 1980s. The relational model that relies on application-specific column headings and multiple inter-related tables precludes a simple solution.

Temporal dimensions of data can be categorized as two broad types: (1) transaction times, which are instances at which data is written, deleted, or updated in the database; or (2) valid times, which are time instances, time intervals, or sets of time intervals at which a data condition is true. For example, the time interval for which a contract is valid is a “valid time.” If a mistake is made in recording a valid time interval in the database, the time interval can be updated, and the instant at which it is updated is a transaction time. Records and citations generally support our beliefs in historical occurrences. However, our general beliefs can change over time. On the other hand, transaction times directly reflect historical records as they happen, and cannot be fabricated or altered. Various solutions have been proposed for recording valid times, requiring special database tables that link the valid time interval or instance to each datum via primary and foreign key columns. A serious problem in recording valid times for attributes is that the query language becomes prohibitively complex, especially when multiple time intervals are recorded for multiple attributes, with overlapping constraints on what time intervals can overlap, abut, co-exist, etc., for these attributes. In the known prior art, there has been no practical, simple solution developed and implemented to address the temporal problem.

Accordingly, there is a need for a generic database schema and associated software that allow those unskilled in database management or programming to manage complex project data, including temporal data, across a variety of industries, applications, and professions.

### SUMMARY

The present invention provides a method, system, and computer program for managing multivarious relational data in a generically useful single matrix representation. The present invention provides a simplified method to those who do not necessarily have database management and programming skills, to organize and manage relational data in a single matrix representation for their own projects and applications. The present invention also provides a method for converting a normalized relational database schema into a single matrix representation.

Embodiments of the method may at least perform the following steps: name or define at least one column in the single matrix representation to represent a row entry unique identifier, have a plurality of row entries in the single matrix representation, establish an inherent relationship between a first row entry in the plurality of row entries and a second row entry in the plurality of row entries when both the first and second row entries in the plurality of row entries have the same unique identifier. Embodiments of the invention may utilize various methods of recognizing that a plurality of row entries has the same unique identifier. For example, computer code programmed as a plug-in, add-in to another program (i.e., macros or middle-ware), or an independent program may be operable to read, write, and search cells within the database table. Embedded functionality analogous to find or search may be integrated into the database application to easily parse data contained within the database table, thereby offering easily accessible functions to be externally called on the database application via a programmable interface to produce the results sought. Other embodiments of the invention may utilize computer code programmed in a separate software component operable to interface with the database table. In the alternative, programs in a separate software component may be written to directly access the cells contained within the database table via programmable interfaces, and logically parse the cells based on algorithms designed to search and match cells per the user's desired search terms.

Embodiments of the invention may store a timestamp value within the unique identifier column of each record. Timestamps are generally extracted from a computing device and represent an approximate or actual transaction time. Timestamps may be determined from internally set clocks via an operating system, via a computer BIOS, via NTP servers over a network and/or the Internet, via an external server module, or via other sources generally available to provide a relative timestamp value. Preferably, the timestamp is extracted from a reliable timestamp source, as the temporal data relies on consistent and reliable timestamp values to maintain record accuracy and temporal legitimacy. Another embodiment of the invention may be operable to simultaneously add a plurality of row entries to the single matrix representation as a related set, while providing each simultaneously added row entry with the same timestamp value. Such an embodiment allows for establishing inherent temporal relationships between pluralities of record entries.

Embodiments of the invention may, in addition to a unique identifier, name or define columns to represent cell attributes, such as: tag name, variable name, supplementary descriptors of the data in the corresponding variable name cell, variable value, variable value format used to identify the format for the data in the corresponding variable value cell, version name, attached file, and/or user name. As with the unique identifier column, these columns can be used to establish further relationships between a first row entry in the plurality of row entries in the single matrix representation and a second row entry in the plurality of row entries when both a first row entry in the plurality of row entries and a second row entry in the plurality of row entries have the save value in one or more cell attribute column. These columns, with at least a unique identifier column, are broadly used independently or cooperatively in various combinations to easily convert or represent a normalized relational database schema. Contrary to typical key-linked tables of a normalized relational database schema, which are highly customized, these columns are generic and application-independent, so that various data for various applications can be managed by the same table configuration and the same accompanying software suite. Another embodiment of the invention can use the above attributes to simplify conversion of a relational database designed with a normalized relational database schema into a single matrix representation for use in a computer program, establishing inherent relationships by use of same-row qualifiers rather than inter-table linkages, or keys. In one embodiment, in addition to using the above column names independently or combined in various configurations, at a minimum, the normalized relational (RDB) database would require that each record in each table be converted into the single matrix representation or new table as follows: (1) the primary key column headings of an RDB often become values under the TagNames column; (2) the column headings of an RDB, including the primary keys, can become values under the Variable Name column; (3) the column headings of an RDB might also become values under the Version column or Supplementary Descriptor column; (4) the values below each column heading of an RDB typically become values under the Variable Values column of the new table on the same row as the corresponding Variable Name or Tag Name—they can also become values under the version or supplementary descriptor columns; (5) the unique identifier (such as the timestamp) establishes relationships among rows (each row contains only one primary datum, or variable value) of the new table like (i) the row numbers in a single-table RDB establish relationships among cells (each row can contain multiple primary data, or variable values), and like (ii) a primary key in a multi-table RDB establishes further relationships among rows of different tables; (6) other columns in the new table, such as TagName, Version, and Units, can be used to establish further relationships among the data like (i) the row numbers in a single-table RDB establish relationships among cells (each cell contains one primary datum, or variable value), and like (ii) a primary key in a multi-table RDB establishes further relationships among rows of different tables.

An alternative embodiment of the invention is a system for managing data in a single matrix representation, comprising a database application and a software component in communication with the database application, wherein the software component is operable to recognize an inherent relationship between a first row entry and a second row entry if both row entries have the same unique identifier or the same value for other cell attributes. The software component may be integrated as part of the database application, or may be a separate application interfacing with the database application and installed on the server in which the database application is running, or it may be integrated as part of the program that is using the database application for data storage and manipulation. The software component is operable to programmatically interface or communicate with the database application, wherein the communication takes place on the same computing device or over a network.

### BRIEF DESCRIPTION OF THE DRAWINGS

Embodiments of the present invention are described in detail below with reference to the attached drawing figures, wherein:

FIG. 1 is a flow chart of a method of managing relational data in a single matrix representation;

FIG. 2 is a schematic depiction of a system that implements the method and/or computer program having the steps set forth in FIG. 1 and in accordance with other embodiments of the present invention;

FIG. 3A is an illustration of an example database table configured using typical RDBMS schema;

FIG. 3B is an illustration of how multiple records and their inherent relationships between multiple tables, such as the database schema described in FIG. 1, may be configured in a single matrix representation with generically useful column headings;

FIG. 3C is another illustration of how multiple records and their inherent relationships between multiple tables, such as the database schema described in FIG. 1, may be configured in a single matrix representation with generically useful column headings;

FIG. 4A is an illustration of how an integer-qualifier to the timestamp value may be utilized in a single matrix representation with generically useful column headings.

FIG. 4B is an illustration of how parent-child relationships may be represented in a single matrix representation with generically useful column headings;

FIG. 5A is an illustration of how the formatting of data can be stored by creating an attribute column generically defining the format for a particular value;

FIG. 5B is an illustration of how formatting may be stored in an attribute column for defining the format for a particular value in a program incapable of understanding generic format definitions;

FIG. 6A is an illustration of how a version attribute column might be used to further add context to each row entry and how an attachment column might allow users to store files in relation to a particular row entry; and

FIG. 6B is an illustration of how a UserName attribute column would be used to identify the user who was responsible for writing the particular row entry to the single matrix representation.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment.” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Embodiments of the present invention are directed to a method and a system for managing relational data in a single matrix representation that is generically useful and application independent. As used herein, a single matrix representation is generally a spreadsheet, table, or database table maintained by an interactive computer application program such as Excel™, Lotus 1-2-3™, the open sourced Gnumeric, Microsoft SQL Server™, MySQL™, Oracle™, and others. Even further embodiments may consider single matrix representations in comma-separated value files (CSV), wherein a matrix is not graphically visible, however the data within the file may be interpreted in matrix form. Even further embodiments may consider single matrix representations spread across multiple tables so that each table or each part of a table is used in the same sense as a column is typically used in a single table. The spreadsheets and tables and the data contained therein can be read, written, manipulated, and searched using various functionalities implemented in the computer application, typically in the form of Application Programming Interfaces (APIs) such as Open Database Connectivity (ODBC) and other standard programming language middleware APIs for accessing data sources. Embodiments of the invention may provide an interface to the table via an interactive computer application, such as a spreadsheet application, wherein the interface is operable to work with a computer program with data entry, record keeping, formulaic calculations, and/or data searching functionalities. Embodiments could utilize the interactive computer application's formula functionality within particular cells for automatically populating cell entries. Other embodiments of the invention may provide an interface wherein the interface is operable to work with a program that is generally used with relational databases, and the relational database is replaced by or interchangeable by the invention described herein.

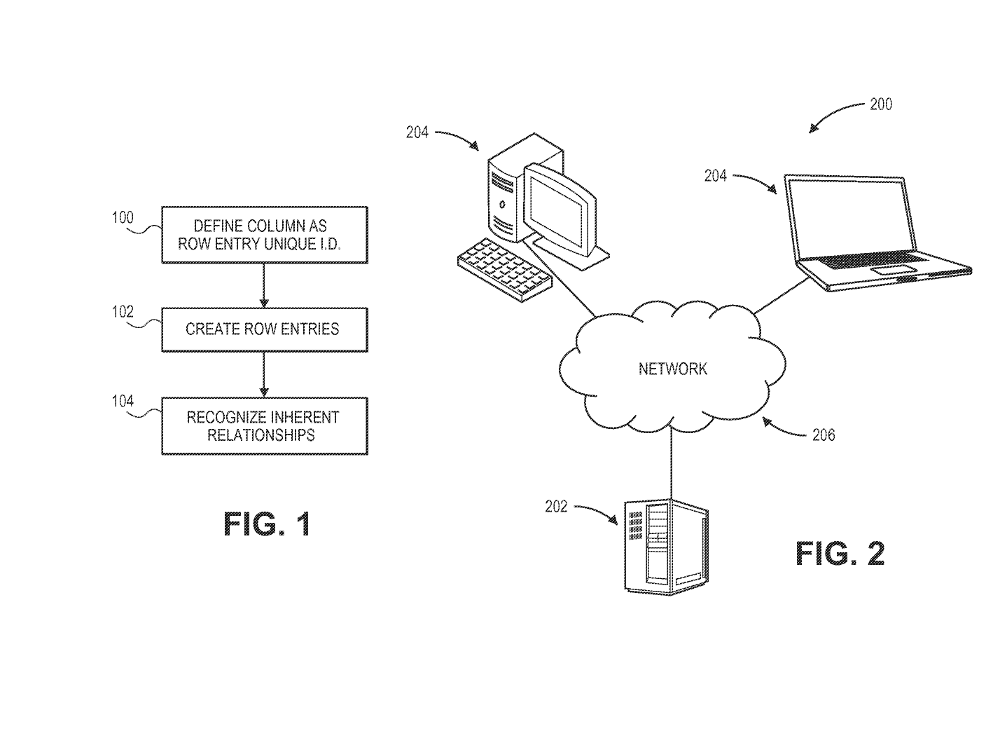

In embodiments of the invention, as discussed below and as described in FIG. 1, relational data can be organized and managed within a single matrix representation by defining at least one column in the single matrix representation to represent a row entry unique identifier 100; having a plurality of row entries in the single matrix representation 102; and establishing an inherent relationship between a first row entry in the plurality of row entries and a second row entry in the plurality of row entries when both the first and second row entries in the plurality of row entries have the same unique identifier 104. In other words, inherent relationships between multiple row entries or “tuples” may be represented as long as any number in the plurality of row entries has the same row entry unique identifier or “attribute value.” Unique identifiers can be used for identifying attributes of related data, such as time of recordation, user names of people who submitted the data, variable names and units describing the data, version names describing the version of the data, and geographical locations associated with the data. Relationships between row entries may be determined by searching through the plurality of row entries and searching for rows that share the same attribute or unique identifier values. In embodiments of the invention, a timestamp may be used as the unique identifier value for all new row entries. In other embodiments, where multiple row entries are simultaneously submitted for recordation, all of the simultaneously submitted row entries would have the same timestamp value, thereby creating an inherent relationship. Further, all row entries that are submitted within a defined range of time for recordation would have timestamp values within a corresponding timestamp range, thereby creating an additional inherent relationship. Some embodiments of the invention may not be programmatically capable of deleting or changing row entries, but would simply create new entries with new updated timestamp values for historical and record-keeping purposes.

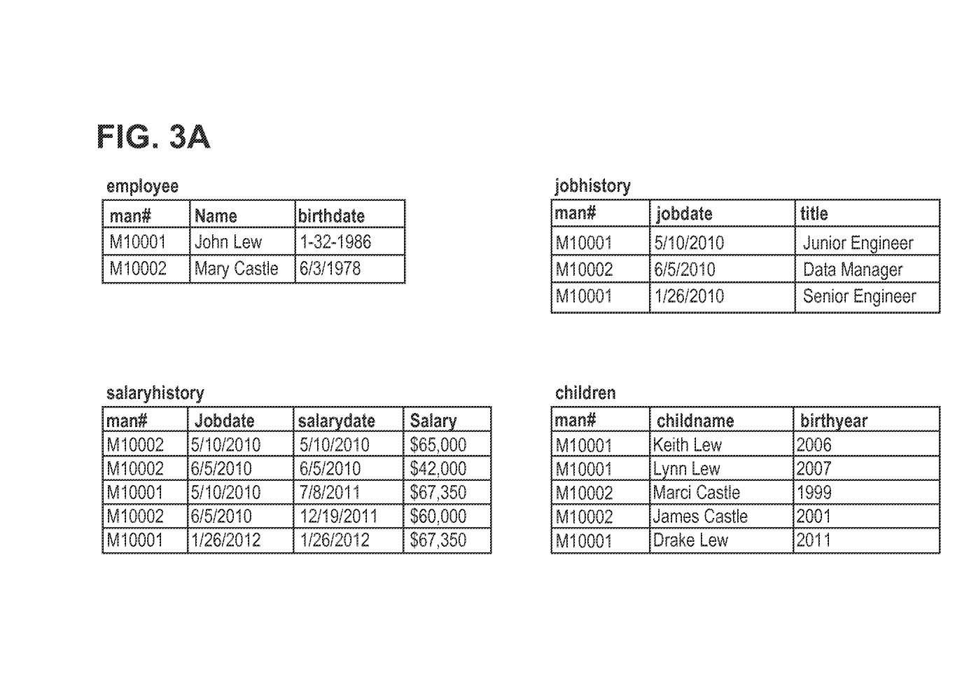

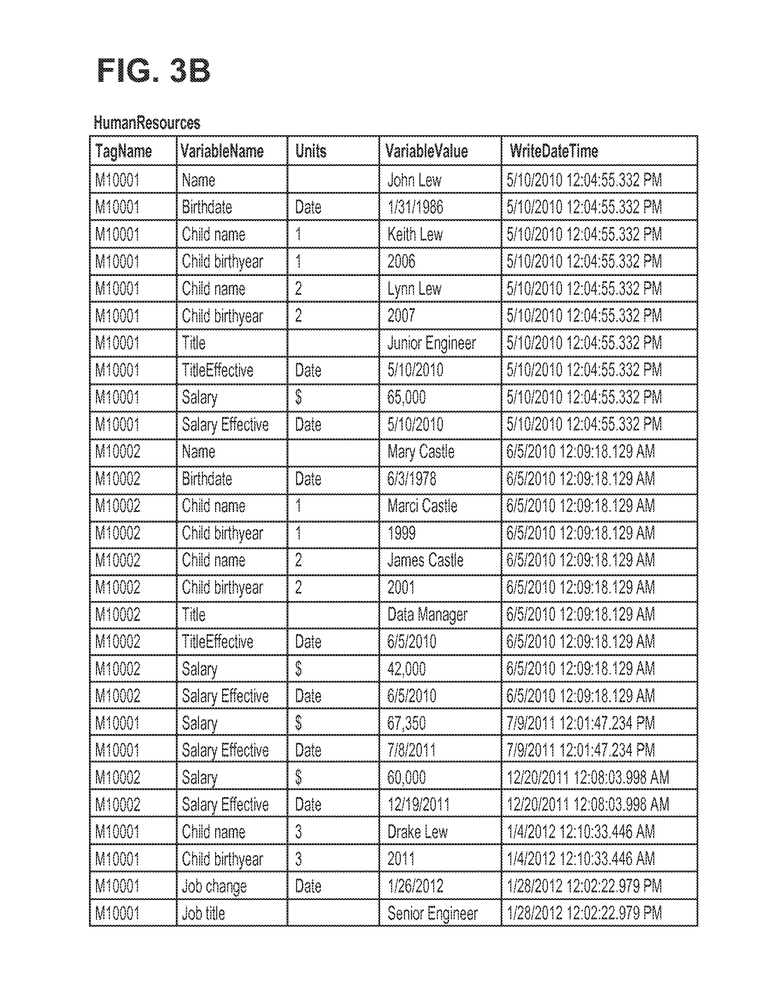

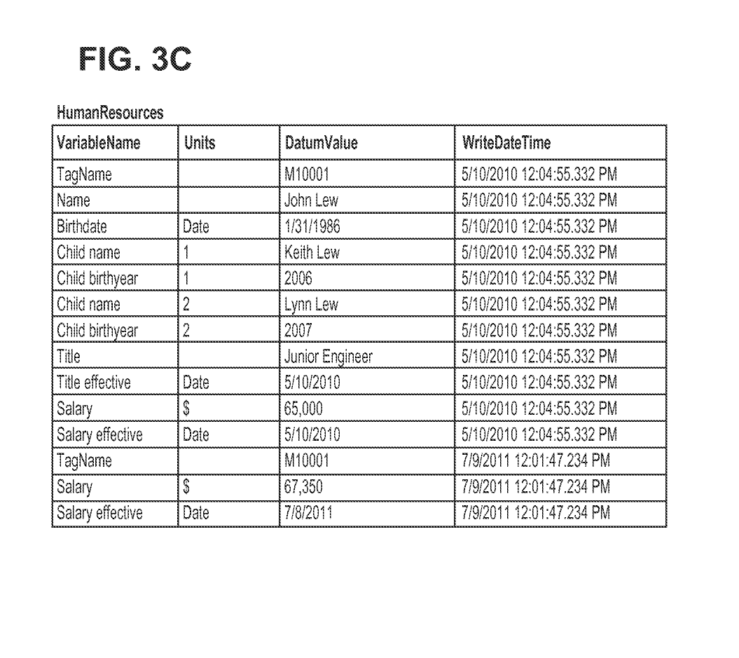

Embodiments of the invention may be structured on a single table to model a normalized relational database model schema, similar to the one illustrated in FIG. 3A, by: (1) defining a first column or attribute in the single matrix representation to represent a row entry's variable name; (2) defining a second column or attribute in the single matrix representation to represent a row entry's supplementary descriptor of the data in said row entry's variable name column, such as the variable's “Units”; and (3) defining a third column or attribute in the single matrix representation to represent a row entry's variable value. The order of columns is generally not important.

The single matrix representation of the relational database model of FIG. 3A is further represented in FIG. 3B, which comprises the first, second, and third columns as described, in addition to the use of a timestamp value within each row entry's unique identifier attribute column to represent when each row entry was submitted for recordation. In this particular example, FIG. 3B is representative of data received by a computer program where predetermined cells of information were simultaneously received by the user for record keeping. Each instance of a submission processed by the computer program shares the same timestamp value, which creates an inherent relationship for all row entries sharing the same timestamp value. FIG. 3B also represents a TagName attribute that serves as an additional attribute that may be used to represent an inherent relationship between multiple row entries. A TagName attribute is a unique name of a specific real-world instance of a type, such as a person's name, or the serial number of a specific product, or a specific sample's number. In the relational database model, a primary key is often, but not always, a TagName in this sense, while other columns, such as a person's birth date, are often like variable names, which are names of attributes that describe the specific person, place or thing. Another embodiment could similarly represent the same data structure and relationships as FIGS. 3A and 3B by removing the TagName attribute column as seen in FIG. 3B and simply defining TagName as another variable, as seen in FIG. 3C. As exemplified in FIG. 3C, all relationships remain intact and the same tasks performed on the data represented in FIG. 3A may be replicated on the data that is represented on a single table as in FIG. 3C. Other embodiments of the invention may include attribute columns representing the following: a row entry's variable format used for identifying a preferred display format for the data in a row entry's variable value column; a row entry's version value; a row entry's attached file value, for enabling record relationships with electronic files; and a row entry's user name value, wherein the user name value identifies a user responsible for the input of the row entry.

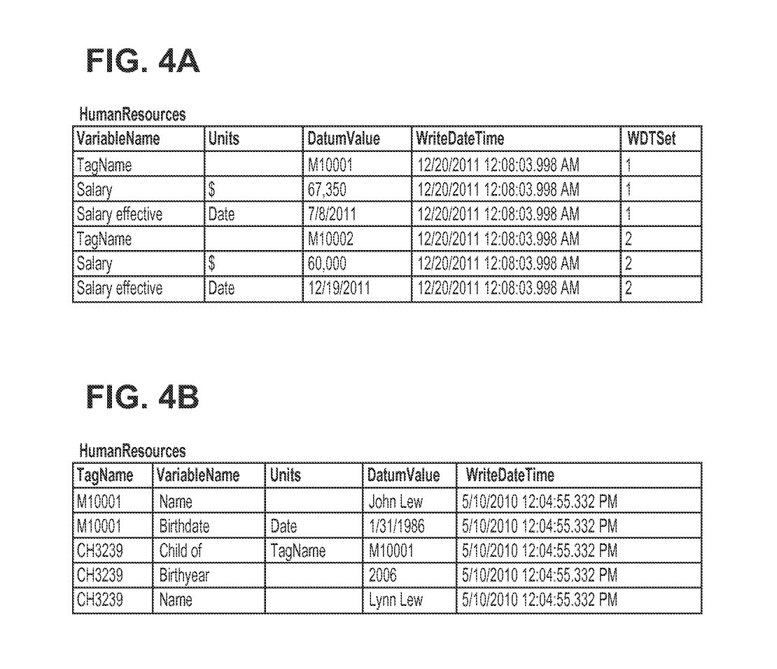

Some embodiments of the invention, as seen in FIG. 4A, may add an attribute column wherein an additional unique identifier column is added, and the unique identifier value for each row entry qualifies each unique timestamp value. In essence, an integer-extender of the timestamp value could allow for more texture of relationships, allowing a user to retrieve all data of a given timestamp value, grouped by the integer-extender value. Other embodiments of the invention can solve parent-child relationships between multiple records by linking a variable of one TagName to another TagName. FIG. 4B demonstrates the storage of hierarchical relationships and represents how the common problem known as “parts explosion,” where an indefinite number of sub-parts must be linked to various super-parts, may be solved. The computer program of the present invention instructs a processor to perform the method of the present invention, and the system of the present invention comprises a computing device having a memory and a processor for performing the above steps.

### System Description

The system of embodiments of the present invention may comprise computing devices, servers, and communications networks to facilitate the functions and features described herein. The computing devices and servers may comprise any number and combination of processors, controllers, integrated circuits, programmable logic devices, or other data and signal processing devices for carrying out the functions described herein, and may additionally comprise one or more memory storage devices, transmitters, receivers, and/or communication busses for communicating with the various devices of the system. In various embodiments of the invention, the computing devices may comprise a memory element, a communication component, a display, and/or a user interface.

The computer program of embodiments of the present invention comprises a plurality of code segments executable by a computing device for performing the steps of the method of the present invention. The steps of the method may be performed in the order shown in FIG. 1, or they may be performed in a different order, unless otherwise expressly stated. Furthermore, some steps may be performed concurrently as opposed to sequentially. Also, some steps may be optional.

The computer program, system, and method of embodiments of the present invention may be implemented in hardware, software, firmware, or combinations thereof using system 200, shown in FIG. 2, which broadly comprises server devices 202, computing devices 204, and a communications network 206. The server devices 202 may include computing devices that provide access to one or more general computing resources, such as Internet services, electronic mail services, and data transfer services, and the like. The server devices 202 may also provide access to one or more databases or single matrix representations such as spreadsheets or database tables, including a spreadsheet or database application that is able to interface with third-party products through Application Programming Interfaces (APIs) such as Open Database Connectivity (ODBC), Component Object Model (COM), other standard programming language middleware APIs for accessing data sources, or other event-driven programming languages such as Visual Basic for Applications (VBA) and other macro programming languages. The tables may also store other information and data necessary for the implementation of the computer program, method, and embodiments of the present invention. Spreadsheet or database applications may be operable to store, search, read, write data, and perform functions on the data contained therein.

The server devices 202 and computing devices 204 may include any device, component, or equipment with a processing element and associated memory elements. The processing element may implement operating systems, and may be capable of executing the computer program, which is also generally known as instructions, commands, software code, executables, applications, apps, and the like. The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, the server devices 202 may further include file stores comprising a plurality of hard disk drives, network attached storage, or a separate storage network.

The computing devices 204 may specifically include mobile communication devices (including wireless devices), work stations, desktop computers, laptop computers, palmtop computers, tablet computers, portable digital assistants (PDA), smart phones, scanners, cash registers, cash drawers, printers, and the like, or combinations thereof. Various embodiments of the computing device 204 may also include voice communication devices, such as cell phones or landline phones. In preferred embodiments, the computing device 204 will have an electronic display, such as a cathode ray tube, liquid crystal display, plasma, or touch screen that is operable to display visual graphics, images, text, etc. In certain embodiments, the computer program of the present invention facilitates interaction and communication through a graphical user interface (GUI) that is displayed via the electronic display. The GUI enables users (i.e., the consumer, a financial institution representative, or an administrator) to interact with the electronic display by touching or pointing at display areas to provide information to the user control interface. In additional embodiments, the computing device 204 may include an optical device such as a digital camera, video camera, optical scanner, or the like, such that the computing device can capture, store, and transmit digital images and/or videos.

The computing devices 204 may include a user control interface that enables one or more users to share information and commands with the computing devices or server devices 202. The user interface may comprise one or more functionable inputs such as buttons, keyboard, switches, scrolls wheels, voice recognition elements such as a microphone, and pointing devices such as mice, touchpads, tracking balls, and styluses. The user control interface may also include a speaker for providing audible instructions and feedback. Further, the user control interface may comprise wired or wireless data transfer elements, such as a communication component, removable memory, data transceivers, and/or transmitters, to enable the user and/or other computing devices to remotely interface with the computing device 204.

The communications network 206 may be wired or wireless and may include servers, routers, switches, wireless receivers and transmitters, and the like, as well as electrically conductive cables or optical cables. The communications network 206 may also include local, metro, or wide area networks, as well as the Internet, or other cloud networks. Furthermore, the communications network 206 may include cellular or mobile phone networks, as well as landline phone networks, public switched telephone networks, fiber optic networks, or the like.

Both the server devices 202 and the computing devices 204 may be connected to the communications network 206. Server devices 202 may be able to communicate with other server devices 202 or computing devices 204 through the communications network 206. Likewise, computing devices 204 may be able to communicate with other computing devices 204 or server devices 202 through the communications network 206. The connection to the communications network 206 may be wired or wireless. Thus, the server devices 202 and the computing devices 204 may include the appropriate components to establish a wired or a wireless connection. In some embodiments, the server device and the computing device may be the same computing device, wherein the computing device servers all functions of the server device.

The computer program of the present invention may run on computing devices 204 or, alternatively, may run on one or more server devices 202. Thus, a first portion of the program, code, or instructions may execute on a first server device 202 or a first computing device 204, while a second portion of the program, code, or instructions may execute on a second server device 202 or a second computing device 204. In some embodiments, other portions of the program, code, or instructions may execute on other server devices 202 as well. In additional embodiments of the present invention, a portion of the information to implement the present invention may be stored on the server device 202, while another portion may be stored on the one or more computing devices 204. The various processes described herein as being performed by or using the computer program may actually be performed by one or more computers, processors, or other computational devices, such as the computing devices 204 and/or server devices 202, independently or cooperatively executing portions of the computer program.

In certain embodiments of the present invention, the computer program may be embodied in a stand-alone program downloaded on a user's computing device 204 or in a web-accessible program that is accessible by the user's computing device 204 via the network 206. For the stand-alone program, a downloadable version of the computer program may be stored, at least in part, on the server device 202. A user can download at least a portion of the computer program onto the computing device 204 via the network 206. In such embodiments of the present invention, the computer program may be an “application,” such as an “app” for a mobile device. After the computer program has been downloaded, the program can be installed on the computing device 204 in an executable format. The executable form of the program permits the user to access embodiments of the present invention via an electronic resource, such as a mobile “app” or website. For the web-accessible computer program, the user may simply access the computer program via the network 206 (e.g., the Internet) with the computing device 204.

Embodiments of the invention are comprised of: a database application operable to store records in a single matrix representation, wherein the table or single matrix representation is comprised of at least one column used to represent a row entry unique identifier, a plurality of row entries, and an interface operable to programmatically read and write the records; a software component in a computer that is in communication with the spreadsheet or database application operable to read and write information to the table or single matrix representation, where said software component is configured to programmatically interface with the database application; and wherein the software component is operable to recognize inherent relationships between row entries when at least one cell in each of the plurality of row entries have the same unique identifier.

Columns, also known as attributes, may be defined or represented by textual descriptors. Generally, column/attribute names are permanent and once defined do not change. In the event a column/attribute name is changed, it is assumed that the cells that fall within that particular column/attribute remain unchanged and that the edit was merely descriptive rather than contextual. In a standard database table, column names are generally defined on the first row or header of the table. Embodiments of the invention may be aware that data is arranged as such, and column/attribute names for each row will be determined by the first row or header and its data cells.

The software component in communication with the database application may be standalone or integrated either in the database application itself or in a computer application utilizing the database application for data storage. “Software component” is to be interpreted broadly in that the component is not necessarily a separate component, although it may be separate, but more so a subcomponent of a computer program that provides functionality for interfacing with a spreadsheet or database application. The software component, when interfacing with the database application, may have functionality of reading, writing, manipulating, performing functions on, searching, and/or deleting data within the table housed by the database application. The software component with its searching functionality, whether utilizing search functionalities programmed in the software component itself or programmed in the database application, is operable to determine inherent relationships between a plurality of row entries by determining matching unique identifiers contained in each row entry. Searches performed on attribute values other than unique identifiers may also be programmed in the software component for various applications and analysis.

Some embodiments of the invention may utilize the software component to directly manipulate the table, in lieu of an available database application interface. Functionalities as described above, such as reading, writing, manipulating, function performing, searching, and deleting of data may be possible if the software component is operable to directly manipulate the data recorded in the single matrix representation. Embodiments may utilize the software component to manipulate the data to uniquely associate it with said software component. For example, embodiments of the software component may want to store data in formats that are not cross-compatible with any other software component. In scenarios such as these, the software component may run an algorithm to encrypt or manipulate data contained within the single matrix representation, while having the ability to decrypt or interpret the data for later use or presentation. Embodiments may even use functions of the database application to manipulate data for the same purposes as described.

Other embodiments of the invention may, after determining at least one inherent relationship between a plurality of row entries, further perform functions or processes on the row entries determined to have achieved an inherent relationship. For example, in the event an inherent relationship between a plurality of row entries is determined, said row entries may be displayed to the user on a display for presentation. Other embodiments may populate cells on a user interface with said row entries' data for the updating of records. When updating records, it is likely that rewriting of the row entries would occur with new timestamps or other unique identifiers to establish a temporal history amongst records. Even further embodiments may perform additional functions or manipulations of the data, for whatever purposes the interfacing software application is programmed to use the relational data for. Embodiments may include visual representations of the data in graphical representations, statistical analysis, record listings, calculations, and any other use for relational data.

Embodiments of the invention may comprise variations of column and attribute names and may be interchanged or used in combination to any extent as desired by the database administrator. Column and attribute names described herein, particularly in the figures and in the method and computer program description below, are non-limiting examples of various implementations of the invention.

### Method and Computer Program Description

The method and computer program of the present invention provide for managing of relational data in a single matrix representation. As set forth in the flowchart of FIG. 1, the basic underlying workflow of managing relational data in a single matrix representation is illustrated. Step 100, the computer program and method of the present invention comprises a first step of defining at least one column in the single matrix representation to represent a row entry unique identifier. Defining of a column is generally known in the art as describing the attribute contained within the column, for each row entry in cross section with the column. In a preferred embodiment, the defining of the column is not limiting or constraining to a particular attribute or variable type. Rather, the defining of the column is an indicator to the user or administrator as to what type of data or categories of data could potentially be found in the associated column. The column definition may also be used by an application operable to organize the data based on the column definition. In a spreadsheet that is used for storage and organization of data, typically the first row is used for defining column names and attributes, with each succeeding row being used for data storage. However, in a database table, column names and attributes are defined in a column header. In a preferred embodiment, the defining of the column will provide generic names in the column header of a database table. After defining at least one column in the single matrix representation to represent a row entry unique identifier and another column in the single matrix representation to represent a variable value, embodiments of the present invention further requires, at Step 102, having a plurality of row entries in the single matrix representation. It is assumed that the user or administrator have a plurality of records stored in the single matrix representation, wherein the records have inherent relationships of interest to the user or administrator. In step 104, the computer program and method of the present invention comprises establishing an inherent relationship between a first row entry and a second row entry in a plurality of row entries when both the first and second row entries have the same unique identifier.

Embodiments of the invention may comprise the use of a timestamp value stored in the unique identifier attribute cell of a new row entry upon its creation. Timestamp values are generally made up of a time of day and date, preferably in the ISO 8601 standard format, however, timestamp values may be of any format as long as consistent throughout all row entries stored in the single matrix representation or table.

Other embodiments of the invention may further comprise a first column defined to represent a row entry's variable name, a second column defined to represent a row entry's supplementary descriptor of the data in said row entry's first variable name column, and a third column defined to represent a row entry's tag name. Defining a column may also be interpreted as labeling, assigning an attribute to, or naming the column. Embodiments of the invention do not require that columns be in any particular order. An embodiment comprised of the above column definitions may typically be used for most applications of storing a normalized relational database schema within a single matrix representation. An example of such an embodiment is represented in FIGS. 3B and 3C, wherein the normalized relational database schema is represented in FIG. 3A. As shown in FIG. 3B, a column defined as TagName functions similarly to that of the man# column of FIG. 3A. In relational database terms, these columns would generally be categorized as keys or primary keys. FIG. 3C further simplifies the single matrix representation by utilizing the timestamp as each row entry's primary key and converting the TagName column to merely another variable. Data for each TagName must be written separately, under a unique timestamp, so that in FIG. 3C the child name of an employee, for example, is uniquely associated with that employee. Embodiments of the invention depend on at least one unique identifier column or attribute to function as a primary key column or attribute would in a relational database schema.

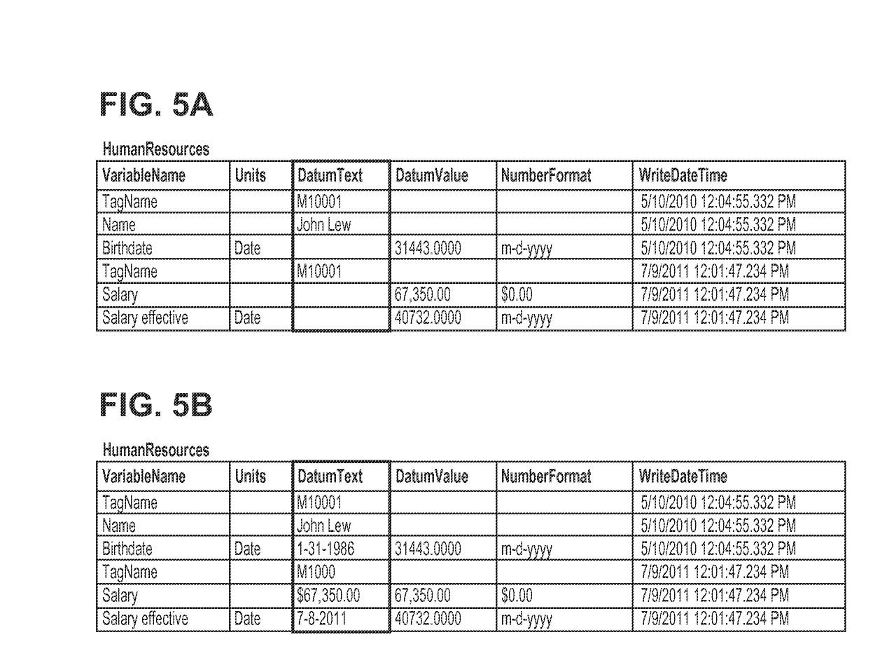

Embodiments of the invention may comprise of a fourth column defined to represent a row entry's variable format, used for identifying a format for the data stored in said row entry's variable value column. FIG. 5A illustrates the use of a NumberFormat attribute column, which is useful when uniquely formatted data, like date or time, is stored in an incompatible format such as float or decimal. A NumberFormat attribute column is also useful in storing the number of significant digits or precision of a decimal or date number that a user prefers to display, while retaining the more precise number in the variable value column. Other embodiments may comprise an additional column, if the stored data is used in programs that do not have the ability to understand formats described by the NumberFormat code of FIG. 5A. FIG. 5B illustrates the use of an additional column where a formatted version of the data can be stored so that a program can retrieve the formatted number as text.

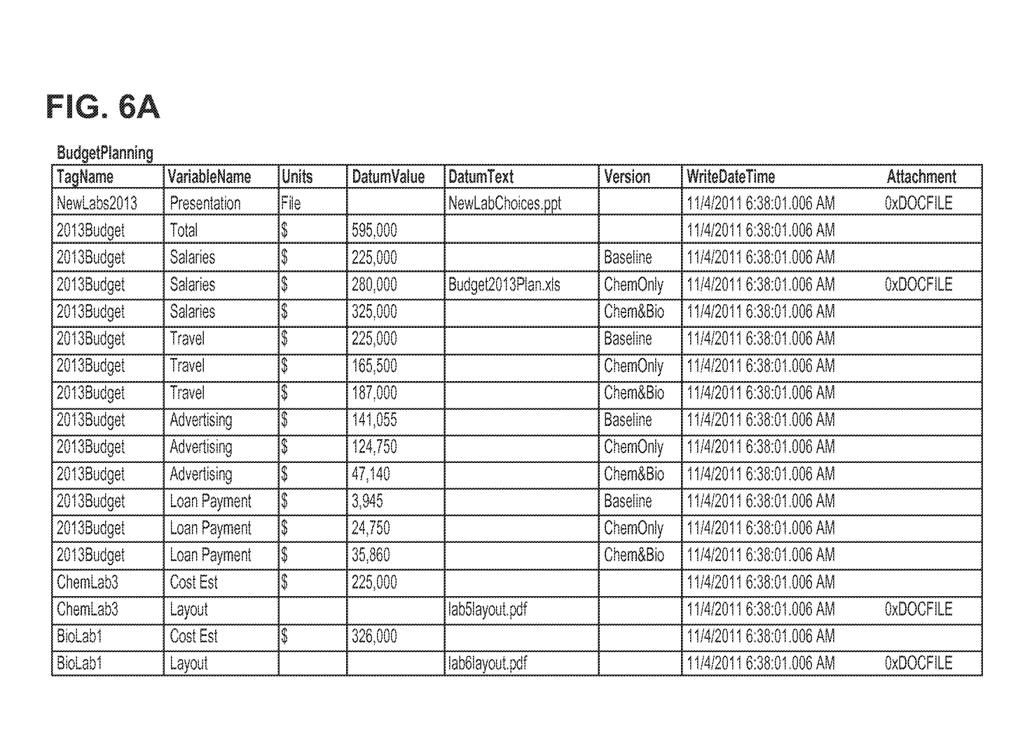

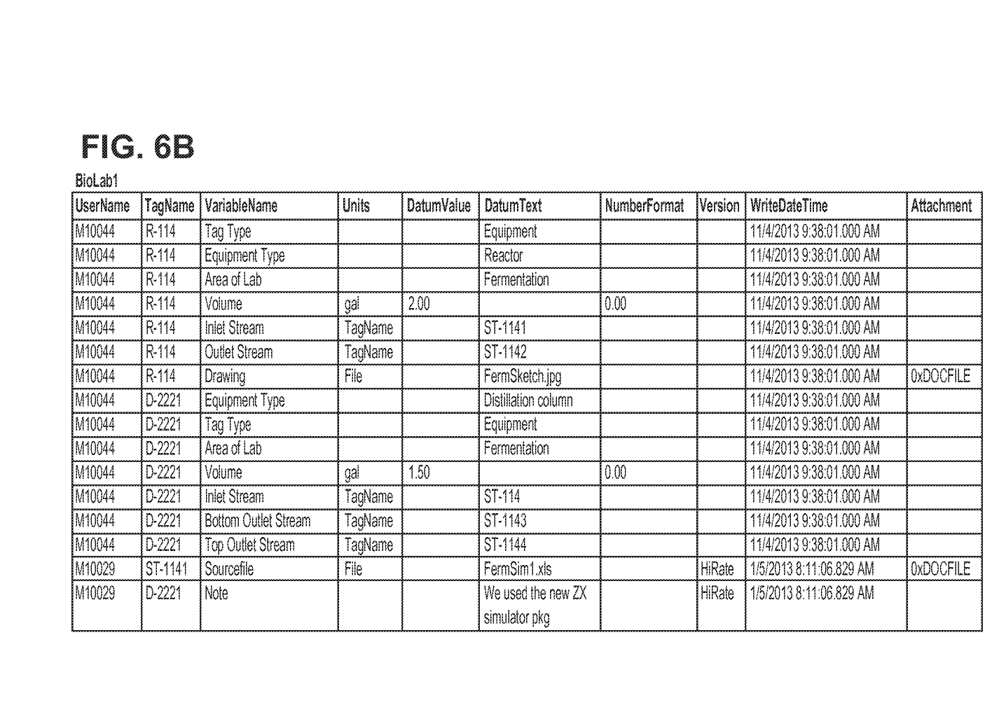

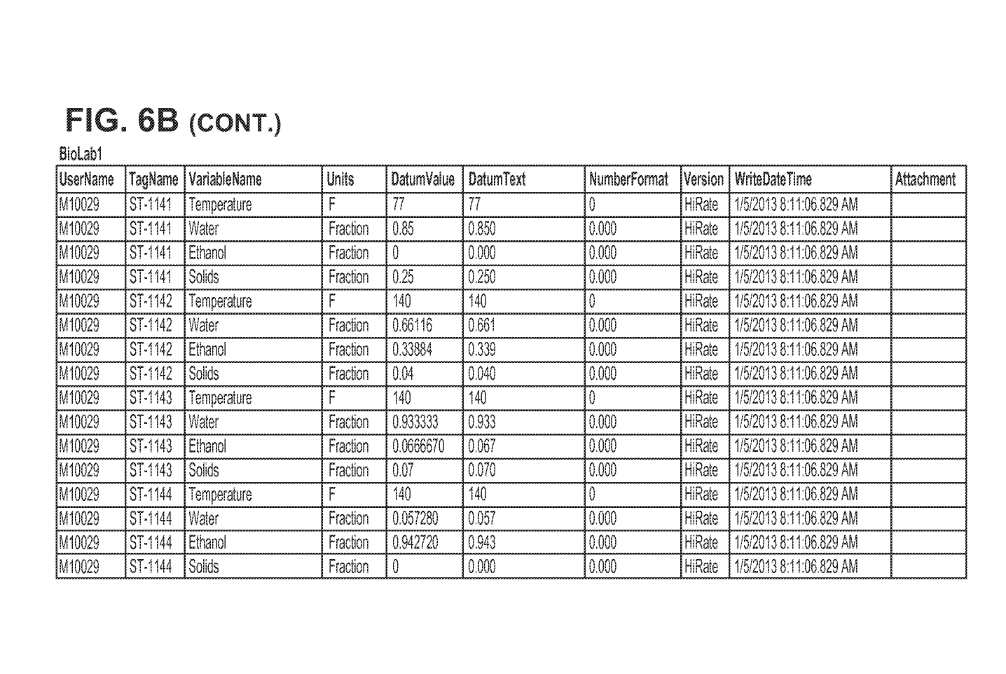

Other embodiments of the invention may comprise a column defined for representing a version. A version column may be used to store a label that represents groups or versions of data stored in the spreadsheet or database table. FIG. 6A illustrates the use of a version column applied to a budget scenario, adding a structural relationship to the data for later retrieval and use. Generally, variations of the version column may be used for categorization or grouping of records stored in the single matrix representation.

Embodiments of the invention may further comprise an attachment column, as illustrated in FIG. 6B, wherein a user may create relationships between stored data and electronic files. Attachment values may be in the form of binary code, file paths, URLs, or other forms of objects handled by the spreadsheet or database application. Another embodiment of the invention comprises a UserName column, also illustrated in FIG. 6B. UserName columns may be applicable for the identification of specific users that wrote particular row entries to the single matrix representation. Embodiments comprising a UserName column may narrow searches by specific users along with any additionally limiting search criteria.

An alternative embodiment of the invention may separate column headings of the single matrix representation amongst a plurality of database tables or spreadsheets. While such an embodiment would potentially incorporate the functionalities of a relational database, the embodiment would still be able to provide the simplification, the use of generic, application-independent headings, and overall functionality of the invention as disclosed herein.

Other embodiments of the invention may receive parameters for a cell from a user (for example, a function within a spreadsheet cell that calls for desired data points), wherein the parameters are programmatically interpreted as coordinates to the single matrix representation and operable to retrieve a cell value based on said coordinates. In other words, a spreadsheet application may be operable to retrieve data from a single matrix representation when a function requests data based on particular coordinates, or in this example, when a function requests data based on parameter values for the generically useful unique identifier or “context” columns, such as TagName, VariableName, Units, Version, and TimeStamp, retrieving the Variable Value value of the same row entry for that particular spreadsheet cell value. On a similar note, other embodiments may perform similar tasks in a graphical manner. For example, computer code in a drawing program may be operable to link shapes to table values by supplying parameter values for the generically useful context columns. Embodiments may provide for graphical outputs of the desired values based on the user's requested parameters. Embodiments may also use the retrieved database table values to define the heights, widths, colors, ratios, or other attributes of a drawing. For example, data in the database for a particular heat exchange may be retrieved and used by a computer program to make a scaled drawing of the heat exchanger.

Although the invention has been described with reference to the preferred embodiment(s), it is noted that equivalents may be employed and substitutions made herein without departing from the scope of the invention. Thus, the invention described herein is entitled to those equivalents and substitutions that perform substantially the same function in substantially the same way.

Having thus described various embodiments of the invention, what is claimed as new and desired to be protected by Letters Patent includes the following:

1. A non-transitory computer-readable medium having a computer program stored thereon for execution by a processor, the computer program operable to manage relational data in a single matrix representation, wherein a single matrix representation is comprised of a plurality of cells in a matrix, wherein a row is comprised of a plurality of horizontally-aligned cells, wherein a column is comprised of a plurality of vertically-aligned cells, wherein the column is not constrained by a particular variable type, such that the cells associated with the column are easily interfaced with various applications, wherein execution of the computer program by the processor performs the steps of:
defining at least one column in the single matrix representation as a unique identifier, such that each cell in said at least one column represents a row entry unique identifier;
creating a plurality of row entries in the single matrix representation, wherein the row entries are comprised of components of related data; and
recognizing an inherent relationship between a first row entry in the plurality of row entries and a second row entry in the plurality of row entries when both the first and second row entries in the plurality of row entries have equivalent data in their respective unique identifier cells.

2. The non-transitory computer-readable medium of claim 1, wherein the unique identifier is a timestamp value representing a time the row entry was submitted for recordation.

3. The non-transitory computer-readable medium of claim 2, wherein execution of the computer program by the processor further performs the step of adding a plurality of row entries to the single matrix representation, wherein said plurality of added row entries have equivalent timestamp values.

4. The non-transitory computer-readable medium of claim 1, wherein the unique identifier is an attribute selected from the group consisting of a tag name, a variable name, a variable unit identifier, a user name, a geographical location, and a version name.

5. The non-transitory computer-readable medium of claim 1, wherein execution of the computer program by the processor further performs the steps of:
defining a first column of a plurality of columns in the single matrix representation to represent a row entry's variable name;
defining a second column of the plurality of columns in the single matrix representation to represent a row entry's supplementary descriptor of the data in said row entry's variable name column; and
defining a third column of the plurality of columns in the single matrix representation to represent a row entry's variable value.

6. The non-transitory computer-readable medium of claim 5, wherein execution of the computer program by the processor further performs the step of:
defining a fourth column of the plurality of columns in the single matrix representation to represent a row entry's variable format used to identify a format for the data in said row entry's variable value column.

7. The non-transitory computer-readable medium of claim 5, wherein execution of the computer program by the processor further performs the step of:
defining a fourth column of the plurality of columns in the single matrix representation to represent a row entry's version name.

8. The non-transitory computer-readable medium of claim 5, wherein execution of the computer program by the processor further performs the step of:
defining a fourth column of the plurality of columns in the single matrix representation to represent a row entry's attached file value.

9. The non-transitory computer-readable medium of claim 5, wherein execution of the computer program by the processor further performs the step of:
defining a fourth column of the plurality of columns in the single matrix representation to represent a row entry's user name value, wherein the user name value identifies a user who was responsible for the input of said row entry.

10. The non-transitory computer-readable medium of claim 1, wherein the single matrix representation is a relational database table.

11. The non-transitory computer-readable medium of claim 1, wherein execution of the computer program by the processor further performs the steps of:
receiving a search request comprised of a set of search criteria;
searching the cells in each of the plurality of row entries for at least one cell meeting a first search criteria in the set of search criteria, wherein if at least one cell in at least one of the plurality of row entries meets the first search criteria, said at least one of the plurality of row entries are appended to a first search result set;
searching the cells in each of the plurality of row entries for at least one cell matching a time stamp value of at least one of the plurality of row entries from the first search result set, wherein if at least one cell in at least one of the plurality of row entries matches a time stamp value of at least one of the plurality of row entries from the first search result set, said at least one of the plurality of row entries matching the time stamp value are appended to a second search result set; and
searching the cells in each of the plurality of row entries in the second search result for at least one cell meeting a second search criteria, wherein if at least one cell in at least one of the plurality of row entries meets the second search criteria, said at least one of the plurality of row entries are appended to a third search result set.

12. The non-transitory computer-readable medium of claim 1, wherein execution of the computer program by the processor further performs the step of:
receiving values for a set of unique identifiers from a user, wherein said values are programmatically interpreted as coordinates to the single matrix representation and operable to retrieve a cell value based on said coordinates.

13. The non-transitory computer-readable medium of claim 1, wherein execution of the computer program by the processor further performs the step of:
receiving values for a set of unique identifiers from a user, wherein said values are linked to shapes in a drawing program and programmatically interpreted as coordinates to the single matrix representation and operable to retrieve a cell value based on said coordinates.

14. The non-transitory computer-readable medium of claim 10, wherein a first column in the single matrix representation is a column of a first relational database table, wherein a second column in the single matrix representation is a column of a second relational database table.

15. A method of managing relational data in a single matrix representation, wherein a single matrix representation is comprised of a plurality of cells in a matrix, wherein a row is comprised of a plurality of horizontally-aligned cells, wherein a column is comprised of a plurality of vertically-aligned cells, wherein the column is not constrained by a particular variable type, such that the cells associated with the column are easily interfaced with various applications, the method comprising the steps of:
defining at least one column in the single matrix representation as a unique identifier, such that each cell in said at least one column represents a row entry unique identifier;
creating a plurality of row entries in the single matrix representation, wherein the row entries are comprised of components of relational data; and
recognizing an inherent relationship between a first row entry in the plurality of row entries and a second row entry in the plurality of row entries when both the first and second row entries in the plurality of row entries have equivalent data in their respective unique identifier cells.

16. The method of claim 15, wherein the unique identifier is a timestamp value representing a time the row entry was submitted for recordation.

17. The method of claim 16, further comprising the step of adding a plurality of row entries to the single matrix representation, wherein said plurality of added row entries have equivalent timestamp values.

18. The method of claim 15, wherein the unique identifier is an attribute selected from the group consisting of a tag name, a variable name, a variable unit identifier, a user name, a geographical location, and a version name.

19. The method of claim 15, further comprising the steps of:
defining a first column of a plurality of columns in the single matrix representation to represent a row entry's variable name;
defining a second column of the plurality of columns in the single matrix representation to represent a row entry's supplementary descriptor of the data in said row entry's variable name column; and
defining a third column of the plurality of columns in the single matrix representation to represent a row entry's variable value.

20. The method of claim 19, further comprising the steps of:
defining a fourth column of the plurality of columns in the single matrix representation to represent a row entry's variable format used to identify a format for the data in said row entry's variable value column.

21. The method of claim 19, further comprising the step of:
defining a fourth column of the plurality of columns in the single matrix representation to represent a row entry's version name.

22. The method of claim 19, further comprising the step of:
defining a fourth column of the plurality of columns in the single matrix representation to represent a row entry's attached file value.

23. The method of claim 19, further comprising the step of:
defining a fourth column of the plurality of columns in the single matrix representation to represent a row entry's user name value, wherein the user name value identifies a user who was responsible for the input of said row entry.

24. The method of claim 15, wherein the single matrix representation is a relational database table.

25. The method of claim 15, further comprising the steps of:
receiving a search request comprised of a set of search criteria;
searching the cells in each of the plurality of row entries for at least one cell meeting a first search criteria in the set of search criteria, wherein if at least one cell in at least one of the plurality of row entries meets the first search criteria, said at least one of the plurality of row entries are appended to a first search result set;
searching the cells in each of the plurality of row entries for at least one cell matching a time stamp value of at least one of the plurality of row entries from the first search result set, wherein if at least one cell in at least one of the plurality of row entries matches a time stamp value of at least one of the plurality of row entries from the first search result set, said at least one of the plurality of row entries matching the time stamp value are appended to a second search result set; and
searching the cells in each of the plurality of row entries in the second search result for at least one cell meeting a second search criteria, wherein if at least one cell in at least one of the plurality of row entries meets the second search criteria, said at least one of the plurality of row entries are appended to a third search result set.

26. The method of claim 15, further comprising the step of:
receiving values for a set of unique identifiers from a user, wherein said values are programmatically interpreted as coordinates to the single matrix representation and operable to retrieve a cell value based on said coordinates.

27. The method of claim 15, further comprising the step of:
receiving values for a set of unique identifiers from a user, wherein said values are linked to shapes in a drawing program and programmatically interpreted as coordinates to the single matrix representation and operable to retrieve a cell value based on said coordinates.

28. The method of claim 24, wherein a first column in the single matrix representation is a column of a first relational database table, wherein a second column in the single matrix representation is a column of a second relational database table.
